(19) United States
(12) Patent Application Publication
(10) Pub. No.: US 2006/0240147 A1
(43) Pub. Date: Oct. 26, 2006

(54) Alcoholic beverages containing corn syrup substitutes

(76) Inventor: Vinod Wasudeo Padhye, Maple Grove, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/346,971

(22) Filed: Feb. 2, 2006

Related U.S. Application Data
(60) Provisional application No. 60/673,594, filed on Apr. 21, 2005.

(51) Int. Cl. C12C 11/00

(52) U.S. Cl. 426/16

(57) ABSTRACT

The invention provides methods of producing fermented malt beverages involving the steps of combining barley malt and water to create a mash; providing a fruit juice adjunct to the mash; extracting a wort from the mash; fermenting the wort to produce a fermented malt beverage; and packaging the fermented malt beverage. In other aspects, the invention provides methods of producing fermented malt beverages involving the steps of combining barley malt and water to create a mash, heating the mash and extracting a wort from the mash after heating; providing a fruit juice adjunct to the wort; fermenting the wort to produce a fermented malt beverage; and packaging the fermented malt beverage. In still further aspects, the inventive methods can include the step of priming a fermented malt beverage by adding fruit juice adjunct to the fermented malt beverage. In composition aspects, the invention provides fermented malt beverages produced by use of fruit juice adjuncts, as well as intermediate products in producing fermented malt beverages with fruit juice adjuncts.

This application claims the benefit of U.S. Provisional Application Ser. No. 60/673,594, filed Apr. 21, 2005, entitled “ALCOHOLIC BEVERAGES CONTAINING CORN SYRUP SUBSTITUTES,” which application is incorporated herein by reference in its entirety.

### FIELD OF THE INVENTION

The invention relates to processes and compositions for the production of fermented malt beverages, such as beer. More particularly, the invention relates to processes for production of beer utilizing fruit juice concentrates as corn syrup substitutes as well as a source of additional saccharide material. The invention also provides fermented malt beverages prepared using fruit juice concentrates as corn syrup substitutes.

### BACKGROUND OF THE INVENTION

The brewing of beer is an ancient art. The basic ingredients of beer have remained unchanged for centuries and include grain malt (typically barley malt), hops, water, and yeast. It is known in the art that grain malt can be replaced in whole or in part by so-called “brewingadjuncts.” Adjuncts are fermentable non-malt materials that supply additional carbohydrates beyond the principal material, malted barley. Adjuncts are typically used to make beer lighter-bodied and/or cheaper. The amount of adjunct used can vary from 30-75% of the malt composition.

Suitable brewing adjuncts include maize, rice, sugar, and various syrups. The two major syrups used in brewing are sucrose- and starch-based. The sucrose-based syrups have been refined from natural sources such as sugar cane or beets. The starch-based syrups are produced from cereals by hydrolysis using acid, exogenous enzymes, or a combination of the two, to produce a range of syrups with different fermentabilities. In recent years, there has been significant development in the range of starch-based syrups produced from corn and wheat. In the United States, these adjuncts are produced exclusively from yellow corn; while in Europe, they are produced from corn and wheat. One example of such an adjunct is brewer's corn syrup, which is a pure, clear, sweet liquid that is specially prepared from corn starch for use in brewing. Corn syrup has become an important brewing adjunct primarily because it is cost effective, non-acidic, and contains fermentable sugars such as fructose and glucose.

The process of preparing fermented malt beverages, such as, beer, ale, porter, malt liquor, and other similar fermented alcoholic beverages (hereinafter referred to simply as “beer” for convenience) is historically well established and generally includes the following steps. First, barley is malted by germination. The purpose of malting is to bring forth enzymes that break down starch and proteins to less complex water soluble compounds (such as amino acids, fermentable sugars, and small peptides). The malted barley is then crushed to create a “grist.” Next, a “mash” of malt is prepared by adding water (and typically brewing adjuncts) to the grist. The mash is heated to solubilize the proteins and convert the starch into sugar and dextrins. Next, the aqueous extract is separated (the wort), which is rich in fermentable sugars. The wort is boiled in a brew kettle to inactivate enzymes, sterilize the wort, extract desired hop components from added hops (thereby adding flavors to the composition), and coagulate certain protein-like substances. The wort is then strained (to remove spent hops and coagulum), cooled, pitched with yeast, and fermented. This fermentation step is commonly referred to as “primary fermentation,” where the wort and yeast convert sugar (glucose) to ethanol and carbon dioxide. After fermentation, a beverage is obtained that typically contains about 3% to about 6% alcohol by weight. The fermented brew, known as “green” or “ruh” beer, is then aged (“lagered”). The ruh beer is usually siphoned off of its sediment (commonly referred to as “racking”). Optionally, the racked beer is subjected to a priming step, where an additional sugar source is added to the beer. Typically, the amount of additional sugar added at the priming stage is relatively small compared to the amount provided during fermentation. Generally, the additional sugar is added at this stage to provide carbonation in the beer. The brew is clarified, filtered, pasteurized, and packaged to produce the desired finished beer.

Although the basic ingredients and process for preparing beer has remained unchanged, the underlying science of brewing has been substantially unraveled in the past 150 years. The understanding of brewing science has spurred enhancements of efficiency and control of beer production. Some major forces driving technological change in the brewing industry include cost savings, quality enhancement, and safety and wholesomeness. Of particular interest in relation to the present invention, the safety and wholesomeness of a beer has become important in recent years.

In recent years, brewing companies have been interested in the possible opportunities that genetically modified (“GM”) barley or yeast might offer. The world's first GM brewing yeast was cleared through government agencies for commercial exploitation in 1994. However, a significant portion of the public has concerns regarding use and consumption of genetically modified organisms (“GMOs”). An increasing number of consumers desire an all-natural beer product that demonstrates desired qualities (such as flavor, clarity, and the like), yet is free of artificial additives, supplements, and/or GMOs.

A genetically modified food is a food product containing some quantity of a genetically modified organism (GMO) as an ingredient. The term “GMO” is commonly used to refer to organisms that have added genes from another species that were inserted through the techniques of genetic engineering. A broader definition sometimes used is an organism in which the genetic material (DNA) has been altered in a way that does not occur naturally by mating or natural recombination. However, this latter definition is not as useful, since all commercial strains of wheat, including organic wheat, have been genetically modified by radiation mutagenesis since the 1950s.

There is varying treatment of GMOs internationally. For example, the European Union and Japan are willing to maintain labeling and traceability standards for GM food products. Thus far, the practice of genetic modification as a scientific technique is unrestricted in the United States.

The first commercially grown GM food crop was the Calgene FlavrSavr™ tomato, which was released into the market in 1994. Subsequent GM food crops included virus-resistant squash, a potato variant that included the Bt organic pesticide, strains of canola, soybean, corn and cotton engineered to be immune to herbicides, and Bt corn. Since the first commercial product introduction in 1994, the cultivation and use of GM food crops has grown significantly. Between 1996 and 2002, the total surface area of land cultivated with GMOs increased by a factor of thirty. Land producing GMO crops grew from 1.7 million hectares (4.2 million acres) in 1996 to 52 million hectares (128 million acres) in 2001. By 2002, land producing GMO crops amounted to 145 million acres, and for 2003 increased to 167 million acres. Among GMO crops, soybean crop represented 63% of total surface area in 2001, maize represented 19%, cotton represented 13%, and canola represented 5%.

The increased presence of GMO products has been accompanied by enhanced public awareness of such products. A series of unrelated food crises during the 1990s (the BSE, or mad cow disease outbreaks, and foot and mouth disease) created consumer apprehension about food safety in general, and eroded the public trust in government oversight of the food industry. This has further fueled widespread public concern regarding GMOs, in terms of environmental protection, health and safety of consumers, and the right to make an informed choice regarding food consumption. Thus, there has been international public interest in food products that can be certified GMO-free.

One approach to providing a GMO-free fermented malt beverage is to provide a GMO-free format for an ingredient of the beverage (for example, corn syrup can be substituted by GMO-free corn syrup). However, it has become difficult for companies to isolate and assure the GMO free feature of such crops as corn and corn syrup. One large concern regarding certification of crops as “GMO-free” is the risk of cross-pollination between GM plants and their wild-type counterparts. Cross-pollination can take place when pollen is carried (typically by wind or insects) from one crop to another. There is conflicting information regarding how far pollen can drift from its source, as well as the effectiveness of such measures as physical barriers (such as isolation distances) and buffer zones to reduce such risk of cross-pollination.

### SUMMARY OF THE INVENTION

It has been discovered that fruit juice concentrates can be used as a substitute for corn syrup as a brewing adjunct. The resulting fermented malt beverage can provide desired organoleptic characteristics (such as body, taste, foam stability, and the like). In addition, and due to the fruit source of the brewing adjunct, fermented malt beverages made in accordance with the invention preferably can be GMO-free.

The ability to substitute fruit juice concentrates for corn syrup in the production of fermented malt beverages is surprising. Fruit juices exhibit several distinct characteristics. For example, fruit juices provide characterizing flavors that can contrast the flavors typically desired for malted beverages. Further, fruit juices are generally acidic with a Brix-to-acid ratio of 10 to 40. In contrast, the Brix-to-acid ratio for corn syrup (a typical adjunct) is typically greater than 800 to provide acceptable malted beverage product. Conventional brewing processes may not welcome high acid product at any significant proportion. Thus, fruit juice concentrates according to the invention are preferably acid-reduced to provide a suitable Brix-to-acid ratio for use with conventional brewing processes and equipment. Moreover, fruit juices typically are more expensive than corn syrup, which can discourage their use as a corn syrup substitute.

According to the invention, a carbohydrate source for brewing (the brewing adjunct) is preferably extracted from waste products of the fruit process industry. These fruit juice products are clarified by removing fibers and other insoluble materials inherent to fruit using mechanical and physical means. The clarified juices are then preferably subjected to resins that remove acid as well as residual quantities of color and flavor. These acid-reduced juice concentrates can be used as brewing adjuncts to provide the desired characteristics described herein. According to preferred aspects of the invention, acid-reduced pineapple juice concentrate with a Brix-to-acid ratio of 500 to 1500 has been produced. Other acid-reduced fruit juice concentrates can be used as well.

Preferably, the fruit juice adjuncts prepared in accordance with the invention provide chemically stable adjuncts for use in preparing fermented malt beverages, and in turn, fermented malt beverages prepared utilizing these adjuncts. Generally speaking, fruit juice includes components that participate in Maillard reactions, which lead to non-enzymatic browning of the juice and/or products that contain the juice. Thus, for products that include fruit juice, such components are undesirable if such browning is to be minimized or avoided. In preferred aspects of the invention, components that participate in reactions that cause browning are removed from the fruit juice. Removal can be accomplished by percolating the clearjuice through a set of resin beads during ion-exchange. Generally, resins remove charged molecules (molecules having positive or negative charges). Thus, typical molecules removed include amino acids, acids, phenols, minerals, and esters. In contrast, simple sugars such as sucrose, glucose, and fructose are neutral molecules that pass through the resin columns unhindered. Compounds such as amino acids are well known for their participation in Maillard reactions, which lead to non-enzymatic browning. Filtration through resin columns can therefore yield fruit juice preparations with a very long storage life.

The fruit juice adjuncts in accordance with the invention resemble corn syrup in that they provide a suitable carbohydrate source for fermentation to produce fermented malt beverages. Similar to corn syrup, the fruit juice that has been passed through resin beads is a sweet product that has increased storage stability. At the same time, the fruit juice adjuncts provide chemically stable ingredients that have a neutral taste, and their use in preparing fermented malt beverages can provide organoleptically desirable fermented malt beverages. It is believed the sugar make-up of the fruit juice adjunct can be different from corn syrup, in that fruit juice adjuncts prepared in accordance with the invention include approximately 40-50% sucrose. Corn syrups are produced after enzymatic treatment and include far less sucrose; the majority of the sugars are fructose and glucose.

Thus, in some aspects, the invention relates to methods of producing fermented malt beverages, the methods comprising steps of:

a. combining barley malt and water to create a mash;

b. providing a fruit juice adjunct to the mash;

c. extracting a wort from the mash;

d. fermenting the wort to produce a fermented malt beverage; and

e. packaging the fermented malt beverage.

In other aspects, the invention relates to methods of producing fermented malt beverages, the methods comprising steps of:

a. combining barley malt and water to create a mash, heating the mash and extracting a wort from the mash after heating;

b. providing a fruit juice adjunct to the wort;

c. fermenting the wort to produce a fermented malt beverage; and

d. packaging the fermented malt beverage.

In preferred methods according to the invention, the fruit juice adjunct constitutes at least about 5% by volume of the wort, or about 5% to about 60% by volume of the wort, based upon the total volume of the wort composition with adjunct.

In still further aspects, the invention relates to methods of producing fermented malt beverages, the method comprising steps of:

a. combining barley malt and water to create a mash;

b. extracting a wort from the mash;

c. fermenting the wort to produce a fermented malt beverage;

d. priming the fermented malt beverage by adding fruit juice adjunct to the fermented malt beverage; and

e. packaging the fermented malt beverage containing added fruit juice adjunct.

In some preferred aspects, a fruit juice adjunct is provided to either the mash or the wort.

In other aspects, the invention relates to a composition comprising wort, hops, and fruit juice adjunct.

In other aspects, the invention relates to a composition comprising green beer and fruit juice adjunct as a priming composition.

In still further aspects, the invention relates to a fermented malt beverage produced from the fermentation of an ingredient mixture comprising malt, yeast, a fruit juice adjunct, and water.

The inventive methods and products can be particularly useful for beer. The invention will now be described in more detail.

### DETAILED DESCRIPTION

The embodiments of the present invention described below are not intended to be exhaustive or to limit the invention to the precise forms disclosed in the following detailed description. Rather, the embodiments are chosen and described so that others skilled in the art can appreciate and understand the principles and practices of the present invention.

Throughout the specification and claims, all percentages used herein are in weight percentages, and are based upon the total weight of the fermented malt composition. As used herein, the pulp in pineapple juice is measured as prescribed in the FDA's standard of identity definition.

In one aspect, the invention provides methods for the production of beer that utilize fruit juices as a brewing adjunct. Fruit juices are suitably processed, as described herein, to provide a fruit juice adjunct. The fruit juice adjunct can be obtained from any suitable fruit source. To facilitate discussion of the invention, use of pineapple juice concentrates to prepare brewing adjuncts for use with fermented malt beverages will be addressed. Pineapple juice adjunct is selected because the pineapple fruit anatomy leaves a good portion of fruit sugar parts that are non-accessible for juice extraction, and pineapple provides a large enough crop to allow an economically feasible application to brewing. However, it is understood that the methods and compositions disclosed are applicable to any suitable fruit source, for example, apple, pear, grape, orange, and the like.

For purposes of discussion of the invention, fruit juice adjuncts are fruit juice (including fruit juice concentrates) that has been processed as described herein to provide desirable characteristics for use in brewing malted beverages. Such desirable characteristics include, for example, a desired Brix level, Brix-to-acid level, and the like, as will be described in more detail hereafter. On the most general level, “fruit juices” are the liquid extract from fruit that is obtained, for example, by mechanical means (such as pressing, and other known means). “Fruit juice concentrates” are fruit juices that have been subject to concentration, such as by evaporation. Typical fruit juice adjuncts according to the invention use, as a starting material, fruit juice concentrates, since these products can be byproducts of juice processing and therefore provide an economical source of material for the inventive methods and products.

Preparation of Juice Adjunct

In one embodiment, pineapple juice adjunct is prepared as follows. Thoroughly washed pineapple fruit is subjected to a Ginaca machine to separate the premium edible meat portion of the fruit. All other pineapple fruit parts are processed, for example, by chopping. For other fruits, any exterior flesh of the fruit can be removed or can be processed along with the interior fruit portion, as desired. The exterior flesh of the fruit will typically be removed if it can interfere with the qualities (such as taste, clarity, and the like) of the final fruit juice adjunct. When the exterior flesh of the fruit is processed along with the interior fruit body, it can be desirable to clean the fruit prior to any processing steps, to remove unwanted debris (including physical debris as well as chemical residues from any treatments applied to the fruit during cultivation). Juice is obtained from the chopped material, for example by centrifuging, pressing, diffusion, or a combination of these techniques.

The obtained pineapple juice typically contains pulp (5-30%), acid (0.2-1.5%, expressed as citric acid), yellow color, and pineapple aroma. According to the invention, at least the acid is removed in preparation of the adjunct. The acid is removed by passing the juice through resins. Removal of the remaining components (pulp, color, and aroma) is optional, although typically accomplished, for reasons described herein. Although pulp, as such, will not hinder fermentation, the pulp is typically removed in order to extend the life of the resins. Ion exchange resins also remove the color and aroma. Color will not interfere with fermentation, and thus it is not required that this component be removed from the juice in preparing the adjunct. In some instances, a strong pineapple aroma may impact the flavor of the final fermented beverage. Thus, it can be preferable to remove the aroma, in instances where there is a concern that the aroma could impact flavor of the final fermented beverage product. Thus, although color and aroma can remain in the juice adjunct, both components are typically removed by virtue of utilization of an ion exchange resin.

To remove these components, the pineapple juice is subjected to milling, followed by centrifugation to remove pineapple meat and coarse pineapple fiber material. The centrifugation speed can be selected based upon such factors as the size and density of the particulate matter to be removed (such as fruit pulp). Centrifugation conditions (such as speed) can be readily determined in light of the description herein and will not be described further.

After centrifugation, the juice is subjected to filtration to remove fine insoluble particles and thereby produce clear pineapple juice. Filtration will typically be performed with filters having a pore size in the range of 0.001 to 0.01 micron. The pore size and filter material should be provided in a suitable size range to allow juice to pass through, but not too small such that filtration rates are unsuitably slow. Typically, the pore size and filter material will be chosen based upon such factors as the size of insoluble particles to be removed, temperature, the pH of the solution, and the like. Suitable filters are commercially available and can be selected based upon the particular application and fruit chosen, given the guidance provided herein.

Following filtration, the clear pineapple juice is filtered through ion-exchange resins to remove acid. Two strong acid cation beds are commonly utilized to remove the cationic species from the juice, namely the ash (K⁺, Ca²⁺, Mg²⁺) and the nitrogenous materials. Weak base resins remove the subsequent acids from the cation effluent and, to some extent, decolorize the stream. Deacidification can involve alternating between strong acid cation beds and weak base resin beads in multiple cycles, as desired. Filtration techniques are well known and can be adapted for use in light of the teaching herein.

The filtered juice can then be concentrated to a desired Brix level. Typical concentration can be achieved by evaporating water from the filtered juice, such as by placing the juice at elevated temperatures and (optionally) reduced pressure for an amount of time sufficient to achieve the desired sugar concentration. Fruit juice concentration to a selected Brix level utilizes standard procedures known in the industry.

After the above steps, a pineapple juice concentrate has been obtained that can be described as “acid reduced,” as the acidity of the juice concentrate has been reduced relative to the starting material. Such reduced acidity provides a desirable Brix-to-acid ratio for brewing of fermented malt beverages and corn syrup substitutes according to the invention. The pH of the emerging concentrate ranges typically from 3 to 6.

The acid-reduced fruit juice concentrate obtained is suitable for use as a fruit juice adjunct. The fruit juice adjunct has a desired sugar content for fermentation utilizing common brewer's yeast. The sugar content of fruit juices is typically measured by Brix degrees (Brix level). The Brix level is a measure of total soluble solids content in the fruit juice (soluble solids, including pigments, acids, glycerol, and sugar, per 100 g of juice). Soluble solids measurements are also used to monitor the progress of fermentation. Typically, Brix tables are used in the juice industry to determine sugar content of a particular composition. The Brix level can be measured using any suitable technology, such as a refractometer, hydrometer, and the like. The Brix measurement defines the ratio of sugar to water and does not take into account the specific gravity of the juice. Thus, the Brix level is an approximate measurement of sugar content of the juice. To determine the amount of sugar in the juice, the following formula can be used:
Weight (in g/L)=(Brix)×(Specific gravity)×10

This is because soluble solids measurements are not simply related to density or concentration. A simple linear relationship does not exist for sugar concentration in liquids. The specific gravity of a sugar solution increases as the concentration of sugar in the solution increases. As apparent soluble solids increase, actual sugar concentration is increasing even more because of the increasing specific gravity. In other words, the specific gravity increase means more sugar per unit volume is in solution.

The sugar concentration (Brix level) can be used to estimate the potential alcohol in finished beer. Moreover, the actual amount or percentage of sugar in the fruit juice concentrate can be used to calculate the amount of concentrate required to raise ferments to a certain alcohol level. For example, grape juice concentrate is generally at 65-68 Brix, this being close to the limit of solubility of glucose and fructose in water. A 68 Brix concentrate contains 908 g/L sugar. The specific gravity of this concentrate is 1.336. Thus, according to the formula above, Weight of sugar(g/L)=68×1.336×10=908. Again, this has important implications for concentrate additions. Assume 10,000 liters of 10 Baume (or 18 Brix) juice that you want to increase to 11 Baume or 19.8 Brix. 1.8 degree Brix increase equals 18 g/l: 10,000×18 g/L=180,000 grams of sugar required. If the grape juice concentrate is 68 Brix, it contains, from above, 908 g/L of sugar. Therefore, volume of concentrate required =180,000/908=198 liters. (Strictly speaking, the volume of concentrate required should be adjusted to take into account the total volume of solution once the concentrate is added, in this case 10,198 liters).

According to the invention, the water content in a formulation can be adjusted to achieve a desired Brix level of a fruit juice adjunct. In some embodiments, the fruit juice adjunct of the invention comprises a Brix level in the range of about 30° to about 85°, or in the range of about 65° to about 75° Brix. Generally, the fermentable sugar content of pineapple juice adjunct is about 70 wt-% or more, or 80 wt-% or more, or 90 wt-% or more, or in the range of 90 wt-% to 100 wt-% of the total soluble solids. The remainder of the juice adjunct can be classified as dry extract. In preferred embodiments, the juice adjunct comprises a pure sugar source, similar to corn syrup.

For fruit juices, calculations of sugar content are usually combined with acid content to develop a Brix-to-acid ratio. These ratios combine the two variables to predict the tartness of the juice, with a higher ratio indicating a less-tart fruit juice. Acidity of the fruit juice can be measured by chemical titration or with pH meters, as known in the art.

Preferably, the fruit juice adjuncts according to the invention have a Brix-to-acid ratio of about 50 or more, or in the range of about 500 to about 1500. These preferred Brix-to-acid ratios are functionally effective for the selected brewing conditions, to provide desirable organoleptic characteristics and suitable carbohydrate sources for fermentation.

In some embodiments, the fruit juice adjunct is essentially starch-free (containing less than about 5% starch or less than about 2% starch). However, it is not critical that the fruit juice adjunct be starch-free, since the presence of starch is not an issue for the inventive compositions and methods. Most fruit juices contain approximately 7 to 22 percent of total sugars in varying proportions of sucrose, glucose and fructose, depending upon the type of fruit.

Optionally, the acid-reduced fruit juice according to the invention can be treated to exhibit a higher dextrose equivalent. For example, acid-reduced pineapple juice can be treated with sucrose hydrolyzing enzymes, such as, for example, invertase. The juice can also be treated with enzymes such as glucose isomerase to modify the proportions of glucose and fructose in the fruit juice adjunct. Such enzyme treatment can be performed at any suitable time during the process, for example, prior to ion exchange or after.

Fruit juice adjuncts could be packed in an old-fashioned manner or aseptically. Aseptic fruit juice adjuncts, by virtue of sterility, can provide flexibility as to when they are added to the wort (for example, sterile adjuncts do not require addition before a boiling or other sterilization step). More particularly, the aseptic fruit juice adjuncts can be added to the wort immediately after lautering or just prior to fermentation.

In some preferred aspects, the inventive fruit juice adjuncts can provide advantages over commonly used brewing adjuncts, such as corn syrup. Importantly, the inventive adjuncts are made from 100% fruit. Because fruit crops are less likely to include GMOs, or be located near crops containing GMOs (thus placing the fruit crops at risk for cross-pollination), the resulting fruit juice adjunct can be utilized to produce “GMO-free” fermented malt beverages. Moreover, for commercial brewers, the use of the invention does not require any substantial modifications of conventional equipment or processes. In particular, the inventive fruit juice adjuncts can be used in place of corn syrup as beer raw material.

Brewing Application

The fruit juice adjunct prepared in accordance with the methods described can be utilized to prepare fermented malt beverages. Generally speaking, the fruit juice adjunct can be provided to a mixture for preparing a fermented malt beverage at one or more of the following brewing stages: to the grist, the mash, the wort, and/or a green beer, as part of priming. When added to the wort, the fruit juice adjunct is preferably added before boiling and prior to fermentation.

It will be appreciated that the type of malt wort and the ratio of wort to adjunct can vary between relatively wide limits, these factors being determinative as to the desired product. For example, in one embodiment, the ratio of malt wort to fruit juice adjunct can be such that the amount of non-fermentable sugars that will carry through to the final product are minimized. In such cases, the adjunct can consist only of highly fermentable sugars, and any non-fermentable sugars in the final product will originate largely from the malt. In this way, increasing the amount of highly fermentable sugar relative to the malt extract in the wort will have the effect of reducing the percentage of non-fermentable sugars and hence the caloric value of the final product. It will also be appreciated that varying the amount of sugar in this way will effectively provide a series of products having differing alcohol contents but having basically similar organoleptic properties.

In some embodiments, the malt wort to fruit juice adjunct ratio can be varied with the objective of brewing a beer product having the desired organoleptic and other properties, the brewing adjunct being either solely highly fermentable sugars or such sugars in combination with adjunct materials. In this instance, the amount of non-fermentable sugars in the final product can be varied and such materials can emanate both from the malt wort and the adjunct materials used.

The invention can utilize any conventional malt known in the art that is suitable for producing beer or other brewed beverages. Alternatively, the malt system can comprise brewers' malt in combination with distillers' malt and/or caramel malt.

Generally, barley malt is steeped with water to produce steeped out barley that is germinated at a fairly low temperature. Germination is carried out with daily mixing and water addition as needed to maintain the moisture content at about 43%. The resulting green malt contains a high content of beer flavor precursors, beer flavor components, and coloring agents. After germination is complete, the green malt is heated at a high moisture content to generate beer flavor precursors, beer flavor components and also to reduce amylolytic enzyme activity. After heating, the malt is dried to a moisture content of 3.5-5.5% and a soluble protein content of 6.5-8%. The dried malt is then crushed to produce a grist.

The grist is then combined with water and heated to a temperature of about 120°-126° F. to produce a mash. Mashing involves grinding and mixing the malt, with 2.5 to 4 times its weight of warm water in large tubs, and mashing the malt at 35-40° C. for 5 to 15 minutes until the mixture forms a thick malt mash. At this stage, the mash contains various malt-derived fermentable sugars. The term “fermentable sugars” includes small molecular weight sugars that are fermentable by yeast into alcohol (ethanol). Illustrative fermentable sugars include maltose and maltotriose. The mash also includes various malt-derived non-fermentable sugars (such as maltotetraose and maltopentaose). The term “non-fermentable sugars” includes large molecular weight sugars conventionally known as oligosaccharides that are not convertible to alcohol by yeast. Substantial quantities of non-fermentable sugars that remain in the mash will produce a final beverage product having a relatively high total sugar level compared to the amount of alcohol therein. As a result, such a product will be high in calories, and will create sensations of “fullness” in consumers when moderate amounts of the product are consumed.

The mash is then permitted to rest for 45-90 minutes without stirring, then heated in increments to a temperature in the range of 70-73° C. while stirring, with time allowed at each step for the various enzymes to convert the starches into fermentable sugars. Following heating, the mash is held for 15-30 minutes, the temperature is raised to 75° C., and the mash is transferred to a lauter unit.

Next, the mash is physically treated to remove solids therefrom (such as barley seed husks and the like). In a preferred embodiment, the mash is transferred to a conventional filtration apparatus known as a lauter tun, or any apparatus known in the brewing art for filtering mash. This portion of the process is generally referred to as lautering. Lautering consists of the removal of the liquid, now termed the “wort,” from the insoluble husks or “spent grains.” The finished mash is allowed to rest in the lautering unit for about ten to thirty minutes, during which time the spent grains settle to the bottom. The lautering tun is equipped with a screen-type filter therein, and a false bottom containing numerous perforations and an outlet leading to the true bottom of the tub. The bottom of the tank is filled with a supply of water that is preferably maintained at a temperature of about 172° F. This water is ultimately used to spray the collected solid materials retained by the filter within the lauter tun to remove desired liquid materials therefrom. The mash is then allowed to settle for 10-20 minutes and run-off begun. The wort is recycled until reasonably clear. The clear wort is then pumped into a brewing kettle. Hot water is run through the spent grains to rinse out, or sparge, any remaining wort The wort solution is boiled vigorously for one to two and one-half hours in the brew kettle. Hops (or extracts thereof) may be added at various stages of the boiling process, depending on the nature (for example, flavor) of the final product that is sought. Any conventional hops can be used in accordance with the invention. Wort boiling can serve a number of objectives, including (1) concentration of the sparged wort, (2) complete inactivation of enzymes that may have survived the final mashing process, (3) coagulation and precipitation of high-molecular weight proteins and solids (termed “kettle break” or “hot break”), (4) extraction of desirable hop constituents, and/or (5) sterilization of the wort.

After boiling, the wort is strained to remove the solids (or “trub”). The clarified fermentable mixture is then cooled to a temperature of about 12-16° C., for example, by passage of the mixture through a conventional heat exchanger system. The cooled fermentable mixture is thereafter transferred into a fermentation tank where it is typically injected with sterile air preferably until the fermentable mixture contains about 8 ppm of oxygen (as determined using conventional oxygen detecting systems).

Next, the fermentation process is initiated. A supply of yeast is obtained. A wide variety of specific yeasts known in the art for producing brewed beverages can be used including, but not limited to, Saccharomyces cerevisiae and Saccharomyces uvarum. The yeast is added in an amount sufficient to achieve a yeast cell count of about 12-60 million cells per ml of fermentable mixture. The particular amount added can be determined using standard techniques known in the brewing art. After 24 hours, fermentation is established and typically proceeds for about 7 to 10 days. During this period, the wort temperature is controlled, since the fermentation process causes the temperature of the wort to rise. Fermentation is permitted to continue until it is determined that there are no fermentable sugars left in the mixture. This can be accomplished by conventional testing procedures, such as a density analysis of the mixture, as well as the use of preliminary pilot studies in order to determine the time required for complete fermentation to occur. Once the yeast has metabolized all the fermentable ingredients in the wort, it settles to the bottom and is subsequently recovered and recycled for use in pitching other brews. As the fermentation process comes to a conclusion, the temperature of the wort begins to drop.

After fermentation is completed, the fermented wort (now termed “green beer”) is drawn off for storage in a cold room tank, or “ruh,” where its temperature is lowered to about 0° C. to about 5° C. Cooling can be achieved using any conventional techniques, such as known heat exchangers.

The green beer may be allowed to remain in the ruh tank for completion of the maturation process, or it may be transferred into a separate maturation tank upon further settling of any remaining yeast and other solids. Depending upon the particular brewery, the beer is allowed to age from about 14 days to about 3 months, during which time the beer clarifies and its flavor develops. Upon maturation, the beer generally is filtered to remove the yeasts and other solids.

As discussed herein, the inventive methods provide flexibility as to the stage at which the fruit juice adjunct is added during brewing. Fruit juice adjunct can be added at the grist, mash, or wort stage of the brewing process. Moreover, fruit juice adjunct can be added at the priming stage of beer preparation (as will be described in more detail). Fruit juice adjunct can be aseptically packed (and thus sterile) or non-sterile. Non-aseptic adjunct should be added before the wort is boiled, prior to primary fermentation. Aseptic adjunct can be used prior to when the yeast is pitched, so long as bacterial or wild yeast contamination is avoided. Although there is a high level of flexibility to the stage at which fruit juice adjunct is added, it is preferred that the adjunct be reconstituted to the desirable Brix level to accommodate the brewing application and added to the wort after lautering (filtration) but prior to wort sterilization.

When fruit juice adjunct is added at the grist, mash, or wort stage, the fruit juice adjunct can be separately cooked to obtain a cooker mash. Production of the cooker mash involves the use of adjuncts along with a 10%-30% portion of the malt (or the addition of commercial enzymes) in order to convert any raw starch into fermentable sugars. The adjuncts and the malt portion are gradually brought to boiling and held there until the products are completely gelatinized. During the final stages of mashing (at the higher temperatures), the cooker mash and the malt mash are combined. Typically, when the Brix value of the fruit juice adjunct is similar to the Brix value of corn syrup, brewing conditions can be substantially similar to standard brewing conditions for brews including corn syrup.

Wort typically includes fermentable sugars in an amount in the range of about 10° to about 20° Brix. When added to the wort, the fruit juice adjunct is preferably added before boiling. According to some aspects, the wort can comprise fruit juice adjunct alone. Optionally, the wort can further include fruit pulp in addition to the fruit juice adjunct. Still further, the wort can also include malted barley and grain materials (such as barley, wheat, corn, rice, and the like). When the wort includes some amount of malted barley and grain materials, the final product can preferably provide desirable organoleptic qualities, such as mouth feel and body desirable for beer. From an organoleptic properties standpoint, the fruit juice adjunct contribution to wort should be at least about 5%, or in the range of about 5% to about 60%, or in the range of about 5% to about 30% (all amounts volume by volume) assuming identical Brix values for the wort and adjunct components. Put another way, the fruit juice adjunct is added in an amount so that the wort extract derived from the mash is comprised of fruit juice adjunct in an amount of at least 5%, based on the total volume of the wort, or in the range of about 5% to about 60%, or in the range of about 5% to about 30% (all amounts volume by volume).

Optionally, a priming step can be included as part of the brewing process. Priming involves providing an additional fermentable sugar source to a green beer and can aid in carbonation of the final fermented malt beverage. Such fermentable sugar source can be any one or more of those mentioned herein. In some aspects of the invention, the fermentable sugar source used at priming can be a fruit juice adjunct. When fruit juice adjunct is added in a priming step, it is important that contamination with undesirable microorganisms be avoided during such addition. The level of fruit juice adjunct addition will depend upon the recipe and desirable properties of the beer. Typically, the amount of fermentable sugar source used at priming is less than that included in the brewing composition for fermentation. It is desirable, however, that fruit juice adjunct not exceed one pound (at 72° Brix) per five gallons of finished product.

The beer can undergo a single- or a double-pass filtration process. To prepare the beer for consumption, it is carbonated to a specified level. Depending upon the form of packaging, the beer can be pasteurized. After final processing of the packaged product (for example, labeling, and the like), the beer is ready for shipment to the consumer. Packaging can include any standard format for fermented malt beverages, such as, but not limited to, bottles, cans, kegs, and the like.

The beer produced according to the invention preferably exhibits desirable organoleptic properties while providing an improved brewing adjunct. In preferred embodiments, use of the inventive fruit juice adjuncts can provide fermented malted beverages that are free of GMO.

In its composition aspects, the invention provides fermented malt beverages produced from the fermentation of an ingredient mixture comprising malt, yeast, a fruit juice adjunct, and water. In other aspects, intermediate products are also provided in accordance with the invention. In some aspects, the invention provides a composition comprising wort, hops, and fruit juice adjunct. These compositions can be fermented to provide a fermented malt beverage as described herein. In still further aspects, the invention provides a green beer and fruit juice adjunct as a priming composition. These compositions can then be clarified, filtered, pasteurized, and packaged to produce a desired finished beer. In accordance with these aspects, the composition can include fruit juice adjunct in an amount of no more than 1 pound of fruit juice adjunct per five gallons of fermented malt beverage, at 72° Brix.

The invention will now be described with reference to the following non-limiting examples.

### EXAMPLE 1

### Production of Fruit Juice Adjunct

Pineapple juice is extracted from pineapple fruit and processed to provide a pineapple juice adjunct as follows. The pineapple is processed, for example, by chopping. Juice is extracted from the chopped material, for example by centrifuging, pressing, diffusion, or a combination of these techniques. The pineapple juice contains soluble solids (8-15%), pulp (5-30%), acid (0.2-1.5%, expressed as citric acid), yellow color, and pineapple aroma. All components, with the exception of soluble solids, are removed to produce pineapple juice adjunct. Such removal is accomplished as follows.

After centrifugation, the raw juice is recovered having a pulp content of 0.5-3%. The raw juice is then pasteurized (105° C. for 30 seconds) and then cooled to a temperature of 55-60° C. The pasteurized raw juice is then subject to enzyme digestion with pectinase (75 ppm) for 30-45 minutes at 45-50° C. The juice is then heated to a temperature of 55-60° C.

Next, the juice is subject to filtration to remove fine insoluble particles to produce clear pineapple juice. The juice is subject to ultrafiltration with a filter having pore size of 0.001 to 0.05 microns. The filtered juice is referred to as “clarified juice.” The clarified juice is then filtered through ion-exchange resins to remove acid (during the filtration process, the aroma and color are also removed).

Optionally, when aseptic juice is desired, the juice is then sterilized at 121° C. for 30 seconds. Optionally, the sterilized juice can be stored in a holding tank and thereafter subjected to evaporation to achieve a desired solids content. The juice is then blended and subject to ultra heat treatment (UHT) at a temperature of 105-108° C. for 30 seconds. The aseptic pineapple juice is then packaged and is suitable for use as a fruit juice adjunct.

The degree of acid, color, or aroma reduction of the pineapple juice can be adjusted by selecting process conditions and/or resins accordingly.

### EXAMPLE 2

### Fermentation of Beer Utilizing a Fruit Juice Concentrate

The fruit juice adjunct produced in Example 1 is utilized as a brewing adjunct in a beer brewing process as follows.

A mash is prepared using crushed malted barley (grist) and water. The mash is stirred and heated to a suitable temperature to solubilize the proteins and convert starch to sugar. The heating is accomplished by increasing the temperature of the mash about 1° C./minute until the target temperature is reached. After heating, the mash is filtered by means of a vessel of the same type as the lauter tun used in breweries and well known to those skilled in the art. Solid matter is separated from soluble material and washed at three steps with 78° C. water. The soluble portion is isolated as the wort.

The wort is introduced into a cooking vessel and is cooked and flavored with suitable ingredients. The final composition of the wort (including the malt extract used to prepare the mash) are identified in Table 1. Conventional brewing processes well known to those skilled in the art are utilized for cooking the ingredients.

TABLE 1
Wort composition.

| Ingredient | Amount |
|---|---|
| Malt extract (dried) | 4 pounds |
| Pineapple juice adjunct | 2.5 pounds for primary fermentation; |
| | 0.25 pounds for secondary fermentation |
| Calcium chloride | 0.5 teaspoon |
| Water | 5.5 gallons |
| Hops | 0.25 pounds |

The pineapple juice adjunct prepared in Example 1 is added to the wort before the hops and prior to boiling in an amount so that about 20% of the resulting wort originates from the added pineapple juice adjunct, and the remaining 80% originates mainly from the malt.

The sediment formed during the cooking step is separated in a whirlpool in accordance with techniques well known in the art. The wort is cooled and aerated for fermentation.

A conventional bottom-fermenting layer of yeast is added to the wort. The primary fermentation takes place under standard conditions, followed by secondary fermentation under standard conditions. For example, primary fermentation using Yeast VTT-A-63015 (Technical Research Centre of Finland, Biotechnical Laboratory) is performed at 10° C. for seven days, followed by secondary fermentation at 10° C. for 4 weeks.

Fermentation results in a green beer that is subsequently aged and clarified under routine brewery cellar conditions. Optionally, the green beer is primed with additional fruit juice adjunct. The primed beer is then pasteurized, carbonated, and packaged to provide a finished beer product.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims. All patents, patent documents, and publications cited herein are hereby incorporated by reference as if individually incorporated.

I claim:

1. A method of producing a fermented malt beverage, the method comprising steps of:
a. combining barley malt and water to create a mash;
b. providing a fruit juice adjunct to the mash;
c. extracting a wort from the mash;
d. fermenting the wort to produce a fermented malt beverage; and
e. packaging the fermented malt beverage.

2. The method according to claim 1 wherein the step of providing the fruit juice adjunct to the mash comprises providing the fruit juice adjunct to the mash in an amount so that the wort extract derived from the mash is comprised of the fruit juice adjunct in an amount of at least 5%, based on the total volume of the wort.

3. The method according to claim 1 wherein the step of providing the fruit juice adjunct to the mash comprises providing the fruit juice adjunct to the mash in an amount so that the wort extract derived from the mash is comprises of the fruit juice adjunct in an amount in the range of 5% to 60%, based on the total volume of the wort.

4. The method according to claim 1 wherein the step of providing the fruit juice adjunct to the mash comprises providing a fruit juice adjunct having a Brix level in the range of 300 to 85° Brix.

5. The method according to claim 1 wherein the step of providing the fruit juice adjunct to the mash comprises providing a fruit juice adjunct having a fermentable sugar content of 70 weight percent or more, based upon the weight of the fruit juice adjunct.

6. The method according to claim 1 wherein the step of providing the fruit juice adjunct to the mash comprises providing a fruit juice adjunct having a Brix-to-acid level of 50 or more.

7. The method according to claim 6 wherein the step of providing the fruit juice adjunct to the mash comprises providing a fruit juice adjunct having a Brix-to-acid level in the range of 500 to 1500.

8. The method according to claim 1 wherein the step of fermenting the wort to produce a fermented malt beverage comprises fermenting the wort to produce a beer.

9. A method of producing a fermented malt beverage, the method comprising steps of:
a. combining barley malt and water to create a mash, heating the mash and extracting a wort from the mash after heating;
b. providing a fruit juice adjunct to the wort;
c. fermenting the wort to produce a fermented malt beverage; and
d. packaging the fermented malt beverage.

10. The method according to claim 9 wherein the step of providing the fruit juice adjunct to the wort comprises providing the fruit juice adjunct to the wort in an amount so that the wort comprises the fruit juice adjunct in an amount of at least 5% based on the total volume of the wort.

11. The method according to claim 9 wherein the step of providing a fruit juice adjunct to the wort comprises providing a fruit juice adjunct having a Brix level in the range of 30° to 85° Brix.

12. The method according to claim 9 wherein the step of providing the fruit juice adjunct to the mash comprises providing a fruit juice adjunct having a fermentable sugar content of 70 weight percent or more, based upon the weight of the fruit juice adjunct.

13. The method according to claim 9 wherein the step of providing the fruit juice adjunct to the mash comprises providing a fruit juice adjunct having a Brix-to-acid level of 50 or more.

14. The method according to claim 13 wherein the step of providing the fruit juice adjunct to the mash comprises providing a fruit juice adjunct having a Brix-to-acid level in the range of 500 to 1500.

15. The method according to claim 9 wherein the step of fermenting the wort to produce a fermented malt beverage comprises fermenting the wort to produce a beer.

16. A method of producing a fermented malt beverage, the method comprising steps of:
a. combining barley malt and water to create a mash;
b. extracting a wort from the mash;
c. fermenting the wort to produce a fermented malt beverage;
d. priming the fermented malt beverage by adding fruit juice adjunct to the fermented malt beverage; and
e. packaging the fermented malt beverage containing added fruit juice adjunct.

17. The method according to claim 16 wherein the step of priming the fermented malt beverage by adding fruit juice adjunct to the fermented malt beverage comprises adding fruit juice adjunct in an amount to provide a fermented malt beverage containing no more than 1 pound of fruit juice adjunct per five gallons of fermented malt beverage, at 72°Brix.

18. The method according to claim 16 wherein a fruit juice adjunct is provided to the mash.

19. The method according to claim 16 wherein a fruit juice adjunct is provided to the wort.

20. A composition comprising wort, hops, and fruit juice adjunct.

21. The composition according to claim 20 wherein the fruit juice adjunct is present in an amount of at least 5% based on the total volume of the wort.

22. A composition comprising green beer and fruit juice adjunct as a priming composition.

23. The composition according to claim 22 wherein the composition comprises fruit juice adjunct in an amount of no more than 1 pound of fruit juice adjunct per five gallons of fermented malt beverage, at 72°Brix.

24. A fermented malt beverage produced from the fermentation of an ingredient mixture comprising malt, yeast, a fruit juice adjunct, and water.
